(19) United States
(12) Patent Application Publication
(10) Pub. No.: US 2025/0354069 A1
(43) Pub. Date: Nov. 20, 2025

(54) EFFICIENT PRODUCT ENDPOINT CONTROL FOR PYROLYSIS REACTIONS

(71) Applicant: Freepoint Commodities LLC, Stamford, CT (US)

(72) Inventors: Mohsen N. Harandi, Calgary (CA); Nithia Thaver, Lake Worth, FL (US); Isaac Yeboah, Houston, TX (US)

(73) Assignee: Freepoint Commodities LLC, Stamford, CT (US)

(21) Appl. No.: 18/663,857

(22) Filed: May 14, 2024

(51) Int. Cl. C10G 7/12; B01D 3/14; B01D 3/34; B01J 6/00; C10B 53/07

(52) U.S. Cl. CPC C10G 7/12; B01D 3/14; B01D 3/343; B01J 6/008; C10B 53/07; C10G 2300/1003

(57) ABSTRACT

A system and method for controlling the endpoint of a product of a pyrolysis reactor is provided. The system can include a pyrolysis reactor, a quench system, a separation section, and a compression and fractionation section. In the system and method, a pyrolysis reactor performs a pyrolysis reaction on a plastic feed to produce an effluent stream, and the effluent stream is transferred to a separation section, wherein it is separated into a heavy liquid byproduct stream and a vapor stream. Portions of the heavy liquid byproduct stream can be recycled to the pyrolysis reactor or used to quench the effluent stream. A portion of the heavy liquid byproduct stream can also be withdrawn from the system as a secondary product. The vapor stream is transferred to a fractionation section, where it is cooled and separated into a light gas stream and a liquid product.

### TECHNICAL FIELD

The present disclosure is generally related to systems and methods for controlling the endpoint of a pyrolysis reaction without using an additional reactor.

### BACKGROUND

Plastic recycling and upgrading technologies have been evolving quickly in the last two decades due to various environmental concerns, including minimizing waste and reducing reliance on fossil fuels. One of the desired outcomes of recycling plastic is to reuse it as plastic. Waste plastic is most often reused as feed material in a petrochemical plant or an oil refinery. This means the product derived from the upgrading process should be processable by a petrochemical plant or an oil refinery. For this to be the case, the product of the upgrading process must meet the specifications for these downstream processes to minimize processing costs and contamination.

One of the most challenging specifications for products of the plastic recycling process to meet is the endpoint requirement to be used as part of the feed for petrochemical plants or the refinery units. Conventional means of addressing this issue include fractionation methods, which can be challenging because they require boiling the products, and some of these products have boiling point temperatures as high as 1,000 to 1,200° F. These conventional methods are also expensive, energy intensive, environmentally undesirable, and also prone to fouling, due to the presence of reactive components in the pyrolysis product, such as di-olefins and heavy waxy hydrocarbons.

The present application addresses these and other challenges related to controlling the endpoint products of pyrolysis reactions.

### SUMMARY

According to a first aspect, a system for controlling the endpoint of the product of a pyrolysis reactor is provided. The system comprises a pyrolysis reactor configured to perform a pyrolysis reaction on a plastic feed to produce an effluent stream that is preferably substantially separated from solid byproducts of the pyrolysis reaction. The system also comprises a separation section, having an inlet for the effluent stream of the pyrolysis reactor, wherein the separation section is configured to separate the effluent stream into a heavy liquid byproduct stream and a vapor stream, and wherein the heavy liquid byproduct stream is collected in the separation section. The system further comprises a pump in fluid connection with the separation section, wherein the pump is configured to receive the heavy liquid byproduct stream from the separation section and optionally recycle a portion of the heavy liquid byproduct stream to the pyrolysis reactor, and use another portion of the heavy liquid byproducts stream as a recycle conduit for quenching the pyrolysis effluent stream after it is cooled, while preferably withdrawing a portion from the system as a heavy liquid secondary product. The system also comprises a compression and fractionation section in fluid connection with the separation section, wherein the fractionation section is configured to receive the vapor stream from the separation section, and further configured to cool and separate the vapor stream into a light gas stream and a liquid product having an endpoint that is at least 100° F. lower than the effluent stream of the pyrolysis reactor.

In another aspect, the separation section is a stripping section that further comprises an inlet for a stripping agent, and wherein the stripping agent facilitates the separation of the effluent stream into the heavy liquid byproduct stream and the vapor stream. In a further aspect, the stripping agent is steam.

In another aspect, wherein the plastic feed comprises waste plastic.

In another aspect, the portion of the heavy liquid byproduct stream in the recycle conduit is configured to cool the effluent stream upstream of the inlet for the effluent stream into the separation section immediately after the effluent stream exits the pyrolysis reactor. In another aspect, the separation section comprises a drum.

In another aspect, the separation section is maintained at a temperature of approximately 400-800° F.

In another aspect, the heavy liquid byproduct stream is approximately 1-25% of the effluent stream from the pyrolysis reactor.

In a second aspect, a method for controlling the endpoint of the product of a pyrolysis reaction of a plastic feed is provided. In the method, a reactor effluent of a pyrolysis reactor is introduced into a separation section. The reactor effluent is then separated into a heavy liquid byproduct stream and a vapor stream in the separation section. A portion of the heavy liquid byproduct stream is recycled to the pyrolysis reactor or to a recycle conduit, and the vapor stream is cooled, compressed, and fractionated into a light gas stream and a liquid product.

In another aspect, the separation section is a stripping section, and wherein a stripping agent facilitates the separation of the reactor effluent into the heavy liquid byproduct stream and the vapor stream. In a further aspect, the stripping agent is steam.

In another aspect, a portion of the heavy liquid byproduct stream is recycled to a recycle conduit for quenching the pyrolysis effluent stream. In a further aspect, a portion of the heavy liquid byproduct stream is withdrawn from the system as a secondary product.

In another aspect, a portion of the heavy liquid byproduct stream is recycled into the pyrolysis reactor.

In another aspect, the plastic feed comprises waste plastic.

In another aspect, the method further comprises cooling the reactor effluent via a quench stream upstream of the separation section immediately after the reactor effluent exits the pyrolysis reactor. In a further aspect, the quench stream comprises an external hydrocarbon stream. In another aspect, the quench stream comprises a portion of heavy liquid byproduct stream that is cooled to generate steam prior to quenching the reactor effluent.

In another aspect, the heavy liquid byproduct stream is approximately 1-25% of the reactor effluent.

In a third aspect, a method for controlling the endpoint of the product of a pyrolysis reaction of a plastic feed in a pyrolysis reactor is provided. In the method, a quench stream is introduced into the reactor effluent of a pyrolysis reaction. The reactor effluent is then introduced into a separation section, and the reactor effluent is separated into a heavy liquid byproduct stream and a vapor stream. A first portion of the heavy liquid byproduct stream is recycled to the pyrolysis reactor for further pyrolysis reactions, and a second portion of the heavy liquid byproduct stream is withdrawn as a secondary product. The vapor stream is processed to produce at least a light gas stream and a liquid product.

In another aspect, a stripping agent facilitates the separation of the reactor effluent into the heavy liquid byproduct stream and the vapor stream. In a further aspect, the stripping agent is steam.

In another aspect, the quench stream comprises an external hydrocarbon stream.

In another aspect, the quench stream comprises a portion of heavy liquid byproduct stream that is cooled to generate steam prior to quenching the reactor effluent.

### BRIEF DESCRIPTION OF THE DRAWING FIGURE

FIG. 1 describes an exemplary system for controlling the endpoint products of a pyrolysis reactor in accordance with one or more embodiments.

### DETAILED DESCRIPTION OF CERTAIN EMBODIMENTS

The present application discloses various systems and methods for controlling the endpoint of the products of pyrolysis reactions. The present systems and methods use pyrolysis reactions to obtain a high yield of plastic products desirable for subsequent reuse in a petrochemical plant or refinery, for example. Examples of pyrolysis reactors that can be used in one or more embodiments include, but are not limited to, fluid-bed reactors, fixed-bed reactors, vacuum reactors, circulating reactors, ablative reactors, auger reactors, rotary kiln reactors, drum reactors, tubular reactors, Heinz retort reactors, vortex reactors, entrained-flow reactors, wire-mesh reactors, moving bed reactors, fixed-batch reactors, and semi-batch reactors.

In accordance with one or embodiments of the present system and methods, a plastic feed is introduced into the pyrolysis reactor and the plastic feed is pyrolyzed in the reactor to produce a reactor effluent. The reactor effluent is then separated into a vapor stream and a heavy liquid byproduct stream within a separation section. In one or more embodiments, the separation section is a stripping section which uses a stripping agent to aid in separation of the reactor effluent. Examples of stripping agents include, but are not limited to, steam, air, inert gases, and hydrocarbon gases, and combinations thereof.

The heavy liquid byproduct stream is then collected and condensed in the separation section, whereupon it is transferred to a pump. In one or more embodiments, the pump recycles a portion of the heavy liquid byproduct stream to the pyrolysis reactor. In at least one embodiment, the pump may recycle a portion of the heavy liquid byproduct stream to a recycle conduit, where it will be used as a quench stream for the reactor effluent. Finally, a portion of the heavy liquid byproduct stream can be withdrawn from the system as a secondary product. Conversely, the vapor stream can be sent to a compression section and/or a fractionation section, where it will be cooled and separated into a light gas stream and a liquid endpoint product. In one or more embodiments, the vapor stream can be transported to a cooling and compression section, where a portion of the vapor stream can be liquefied before it enters the fractionation section.

These and other aspects of the present system and method are described in further detail below with reference to the accompanied drawing figure, in which one or more illustrated embodiments and/or arrangements of the apparatus and methods are shown.

Further, as used in the present application, the term “approximately” or “about” when used in conjunction with a numerical value refers to any number within 5, 3 or 1% of the referenced numerical value, including the referenced numerical value.

As used herein, the term “pyrolysis” generally refers to the chemical decomposition of condensed substances by heating in an inert (oxygen-free) environment at high temperatures.

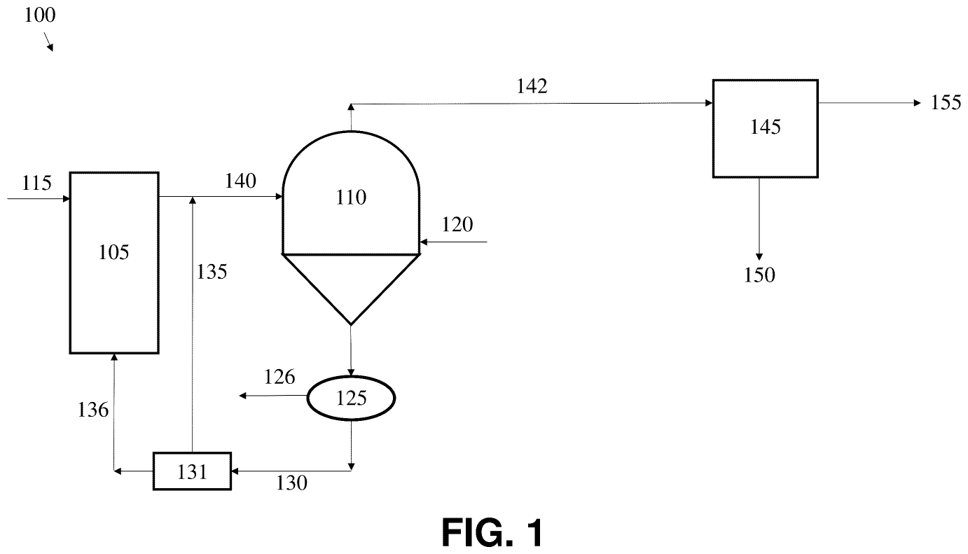

FIG. 1 shows a diagram of an exemplary system 100 for controlling the endpoint of the products of pyrolysis reactions in accordance with one or more embodiments. With reference now to FIG. 1, in one or more embodiments, the system 100 includes a pyrolysis reactor 105 configured to pyrolyze a plastic feed 115 to produce a reactor effluent 140. In one or more embodiments, the reactor effluent 140 is substantially separated from solid content of the effluent (solid byproducts of the pyrolysis reaction). In one or more embodiments, the plastic feed 115 comprises waste plastic. The system 100 also comprises a separation section 110. In one or more embodiments, the separation section 110 is a stripping section which has inlets for the reactor effluent 140 and a stripping agent 120, and is configured to separate the reactor effluent 140 using the stripping agent 120. Specifically, the separation section 110 can be configured to separate the effluent stream 140 into a heavy liquid byproduct stream and a vapor stream 142 via the stripping agent 120. Examples of stripping agents include, but are not limited to, steam, air, inert gases, and hydrocarbon gases, and combinations thereof. In at least one embodiment, the stripping agent is a fraction or portion of the light components produced in the pyrolysis reaction which are recycled to the separation section after compression and/or fractionation. The heavy liquid byproduct stream is collected in the bottom of the separation section 110. In one or more embodiments, the separation section 110 is a separation drum. In one or more embodiments, the separation drum may contain one or more trays. The separation drum may contain 5-30 trays, and in other embodiments, 5-10, 10-15, 15-20, 20-25, or 25-30 trays.

In at least one embodiment, the separation section 110 is maintained at a temperature of approximately 400-800° F. In at least one embodiment, the separation section 110 is maintained at a pressure equal to the outlet pressure of the pyrolysis reactor, minus the piping pressure drop from the pyrolysis reactor to the stripping section 110. In at least one embodiment, the separation section 110 is maintained at a pressure of approximately 10-150 Psia, or in certain embodiments, approximately 10-50 Psia, 50-70 Psia, 70-90 Psia, 90-110 Psia, 110-130 Psia, or 130-150 Psia. In at least one preferred embodiment, the stripping agent 120 is steam. In embodiments in which the stripping agent 120 is steam, the separation section 110 can further comprise a steam stripping column (not shown). This steam stripping column can contain packing material, trays, or other materials to increase the surface contact between the steam and the products of the pyrolysis reaction. Examples of trays can include, but are not limited to, sieve trays, valve trays, and bubble cap trays. Some examples of column packing techniques for stripping columns are random packing and structured packing. Other examples of packing materials for the steam stripping column can include, but are not limited to, perforated embossed metal, plastic, wire gauze, and Raschig rings, which in turn can be made of ceramic, metal, or glass. Additional considerations for the stripping column are column height, the operating conditions, and the number of stages. The number of stages can be set based on the disposition of the bottoms of the stripper. For instance, the number of stages can be varied depending on the desired strength of the stripping operation. For example, if the heavy liquid byproduct stream is recycled to the reactor for conversion then less sever stripping is use, but in embodiments in which the heavy byproduct is recovered, the stripping can be more severe to ensure minimizing loss of valuable products such as C20 lighter components to the lower value heavy byproduct.

With continued reference to FIG. 1, in one or more embodiments the system 100 can also comprise a pump 125 in fluid connection with the separation section 110, wherein the pump 125 is configured to receive the heavy liquid byproduct stream from the separation section 110 and optionally recycle a portion of the heavy liquid byproduct stream via recycle conduit 130 to the pyrolysis reactor 105 via conduit 136 or to a recycle conduit 135 for quenching the pyrolysis reactor effluent 140. In one or more embodiments, the portion of the heavy liquid byproducts stream is recycled for quenching the pyrolysis effluent stream after it is cooled. In at least one embodiment, a portion of the heavy liquid byproduct stream is withdrawn from the system at the pump 125 as a heavy liquid secondary product 126. In at least one embodiment, the recycle conduit 130 can comprise a heat recovery unit 131 (e.g., steam generator), where steam can be generated from the available heat. In certain embodiments, a large portion of the heavy liquid byproduct stream is recycled for quenching the pyrolysis effluent stream after the heavy liquid byproduct stream passes through the heat recovery unit 131. In at least one embodiment, the condensed heavy end byproduct stream is less than 25% of the reactor effluent 140, or approximately 1-25% of the reactor effluent 140, or in certain embodiments approximately 5-25% of the reactor effluent 140.

In one or more embodiments, the pyrolysis reactor effluent 140 is cooled via a quench stream in conduit 135. In one or more embodiments, the quench stream comprises a portion of the recycled heavy liquid byproduct stream in the recycle conduit 130. In at least one embodiment, the quench stream comprises a hydrocarbon stream from an external source. In at least one embodiment, the quench stream 135 itself can be cooled to generate steam prior to quenching the reactor effluent 140. The quench stream can be cooled via the steam generator (heat recovery unit 131) that removes heat from the quench stream. One purpose of the cooled recycled heavy liquid byproduct stream is to prevent potential coking of the unstable compounds in the hot reactor effluent. In other words, to minimize the chance of reactor effluent coking, the cooled recycle stream enters the reactor effluent line preferably immediately after it leaves the reactor to minimize residence time and available surface area for coking reaction. In one or more embodiments, the quench temperature is less than 690° F. In at least one embodiment, the quench temperature is 500-600° F.

With continued reference to FIG. 1, in one or more embodiments the system 100 can further comprise a compression and fractionation section 145 in fluid connection with the separation section 110, wherein the fractionation section 145 is configured to receive the vapor stream 142 from the separation section 110, and further configured to cool and separate the vapor stream 142 into a light gas stream 150, such as C4-, and a liquid product 155 that preferably contains C5-700° F. components and has at least 100° F. lower endpoint than the pyrolysis reactor effluent. In certain embodiments, the fractionation section 145 can include a cooling and compression section that is provided for to liquify a portion of the vapor stream 142 before fractionation is utilized at a higher pressure. The vapor stream can be cooled and fractionated into a light gas stream and a liquid product with a relatively low endpoint compared to the reactor effluent.

In one or more embodiments, the compression can comprise centrifugal, liquid ring, or reciprocating compression equipment with a subsequent cooler and a flash drum. In at least one embodiment, the compression and fractionation section 145 separates the vapor stream 142 into a C4-product and a C5+product. In at least one embodiment, the bottom components of the flash drum can be stabilized in a debutanizer to meet a Reid vapor pressure (RVP) requirement for the C5+ product that is relatively free of the waxy heavy components contained in the reactor effluent. In at least one embodiment, the C4-product leaving the flash drum can be further separated into liquefied petroleum gas (LPG) and C2-fuel gas products.

In one or more embodiments, the cooled vapor stream 142 can be contacted with caustic to remove corrosive acids (not shown). In at least one embodiment, the caustic is introduced to the vapor stream 142 when the vapor stream is cooled and partially condensed at a temperature of approximately 200-240° F.

Although much of the foregoing description has been directed to system and method for controlling an endpoint of the product of a pyrolysis reactor, the system and method disclosed herein can be similarly deployed and/or implemented in scenarios, situations, and settings far beyond the referenced scenarios. It should be further understood that any such implementation and/or deployment is within the scope of the methods described herein.

It is to be further understood that like numerals in the drawings represent like elements through the figure, and that not all components and/or steps described and illustrated with reference to the figure are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings are shown accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed:

1. A system for controlling the endpoint of the product of a pyrolysis reactor, comprising:
a pyrolysis reactor configured to perform a pyrolysis reaction on a plastic feed to produce an effluent stream that is preferably substantially separated from solid byproducts of the pyrolysis reaction;
a separation section, having an inlet for the effluent stream of the pyrolysis reactor, wherein the separation section is configured to separate the effluent stream into a heavy liquid byproduct stream and a vapor stream, wherein the heavy liquid byproduct stream is collected in the separation section;
a pump in fluid connection with the separation section, wherein the pump is configured to receive the heavy liquid byproduct stream from the separation section and optionally recycle a portion of the heavy liquid byproduct stream to the pyrolysis reactor, and use another portion of the heavy liquid byproducts stream as a recycle conduit for quenching the pyrolysis effluent stream after it is cooled, while preferably withdrawing a portion from the system as a heavy liquid secondary product; and
a compression and fractionation section in fluid connection with the separation section, wherein the fractionation section is configured to receive the vapor stream from the separation section, and further configured to cool and separate the vapor stream into a light gas stream and a liquid product having an endpoint that is at least 100° F. lower than the effluent stream of the pyrolysis reactor.

2. The system of claim 1, wherein the separation section is a stripping section that further comprises an inlet for a stripping agent, and wherein the stripping agent facilitates the separation of the effluent stream into the heavy liquid byproduct stream and the vapor stream, wherein the stripping agent is preferably steam.

3. The system of claim 1, wherein the plastic feed comprises waste plastic.

4. The system of claim 1, wherein the portion of the heavy liquid byproduct stream in the recycle conduit is configured to cool the effluent stream upstream of the inlet for the effluent stream into the separation section immediately after the effluent stream exits the pyrolysis reactor.

5. The system of claim 1, wherein the separation section comprises a drum.

6. The system of claim 1, wherein the separation section is maintained at a temperature of approximately 400-800° F.

7. The system of claim 1, wherein the heavy liquid byproduct stream is approximately 1-25% of the effluent stream from the pyrolysis reactor.

8. A method for controlling the endpoint of the product of a pyrolysis reaction of a plastic feed, the method comprising:
introducing a reactor effluent of a pyrolysis reactor into a separation section;
separating the reactor effluent into a heavy liquid byproduct stream and a vapor stream in the separation section;
recycling a portion of the heavy liquid end byproduct stream to the pyrolysis reactor or to a recycle conduit; and
cooling, compressing, and fractionating the vapor stream into a light gas stream and a liquid product.

9. The method of claim 8, wherein the separation section is a stripping section, and wherein a stripping agent facilitates the separation of the reactor effluent into the heavy liquid byproduct stream and the vapor stream.

10. The method of claim 9, wherein a portion of the heavy liquid byproduct stream is recycled to a recycle conduit for quenching the pyrolysis effluent stream.

11. The method of claim 10, wherein a portion of the heavy liquid byproduct stream is withdrawn from the system as a secondary product.

12. The method of claim 8, wherein a portion of the heavy liquid byproduct stream is recycled into the pyrolysis reactor.

13. The method of claim 8, wherein the plastic feed comprises waste plastic.

14. The method of claim 8, further comprising:
cooling the reactor effluent via a quench stream upstream of the separation section immediately after the reactor effluent exits the pyrolysis reactor, wherein the quench stream preferably comprises an external hydrocarbon stream or a portion of the heavy liquid byproduct stream that is cooled to generate steam prior to quenching the reactor effluent.

15. The method of claim 9, wherein the stripping agent is steam.

16. The method of claim 8, wherein the heavy liquid byproduct stream is approximately 1-25% of the reactor effluent.

17. A method for controlling the endpoint of the product of a pyrolysis reaction of a plastic feed in a pyrolysis reactor, the method comprising:
introducing a quench stream into the reactor effluent of a pyrolysis reaction;
introducing the reactor effluent into a separation section;
separating the reactor effluent into a heavy liquid byproduct stream and a vapor stream;
recycling a first portion of the heavy liquid byproduct stream to the pyrolysis reactor for further pyrolysis reactions, and withdrawing a second portion of the heavy liquid byproduct stream as a secondary product; and
processing the vapor stream to produce at least a light gas stream and a liquid product.

18. The method of claim 17, wherein a stripping agent facilitates the separation of the reactor effluent into the heavy liquid byproduct stream and the vapor stream, further wherein that stripping agent is preferably steam.

19. The method of claim 17, wherein the quench stream comprises an external hydrocarbon stream.

20. The method of claim 17, wherein the quench stream comprises a portion of heavy liquid byproduct stream that is cooled to generate steam prior to quenching the reactor effluent.
